(19) United States
(12) Patent Application Publication
(10) Pub. No.: US 2010/0025976 A1
(43) Pub. Date: Feb. 4, 2010

(54) OCCUPANT RESTRAINT

(76) Inventors: Philip G. Murtha, Hampshire (GB); Leslie P. Neil, Hampshire (GB)

Correspondence Address: NIXON & VANDERHYE, PC, 901 NORTH GLEBE ROAD, 11TH FLOOR, ARLINGTON, VA, 22203, US

(21) Appl. No.: 12/516,689

(22) PCT Filed: Nov. 27, 2007
(86) PCT No.: PCT/GB07/04523

§ 371 Date: May 28, 2009

(30) Foreign Application Priority Data
Nov. 30, 2006 (GB) 0623949.5

(51) Int. Cl. B60R 22/00; B60R 22/36; B60R 22/04

(52) U.S. Cl. 280/801.1; 280/806; 280/802

(57) ABSTRACT

This invention relates to the field of load restraint systems, particularly occupant restraint systems that provide improved restraint by adopting more closely the contour of the occupant and particularly actively controlled restraint systems which respond to the external environment and hazardous situations. There is provided an articulated restraint which more closely adopts the profile of an occupant to provide a better and closer fitting restraint. Improving the fit of the restraint to the occupant provides better survivability in impact scenarios. The articulated restraint is formed from a series of elements which are joined by a connecting cord. When tension is applied to the cord the elements compress together and adopt the form of the occupant, further tension forces the elements to form a substantially rigid conformation which retains the occupant in a seat. There is further provided an active restraint system for actively controlling the tension in the connecting cord in response to external forces or hazardous events. The restraint and active restraint system may be used in place of conventional five point harnesses and seat belts to provide improved survivability in impacts and better restraint in the seating position for manoeuvres resulting in significant G-forces.

This invention relates to the field of load restraint systems, particularly occupant restraint systems that provide improved restraint by adopting more closely the contour of the occupant and particularly actively controlled restraint systems which respond to the external environment and hazardous situations.

There are many vehicles, vessels and craft which require the use of restraint systems. Particularly well known examples are seat belts which are commonly used in cars, which typically contain a lap strap portion and typically (at least in UK and Europe) a shoulder strap portion.

Other vehicles which use restraints are aircraft, typically fast moving jets, which employ a five point harness. The five point harness comprises two shoulder straps and 3 lower abdomen straps. Other fast moving vehicles where multi-axis impacts are commonly experienced, such as in competitive motor-sports, or water sports, for example power boats, commonly use a 5 point harness system.

The restraint must perform the role of restraining the occupant in a hazardous situation such as an impact or rapid deceleration, but must also maintain an occupant in a position which enables them to maintain full control of the craft.

The occupant should therefore be kept in the optimum position i.e. held into the seat to minimise injury during a crash or heavy landing. Ideally the restraint should be fully adjustable in order that all sizes of occupant are offered the same amount of protection during normal use and or crash/impact conditions.

Current restraint design is based around the use of a webbing material which provides the strap portions of the restraint. The webbing straps are fixed or anchored to the seats or other parts of the craft and extend over the occupant and are connected to a release mechanism, which secures the occupant against the seat. When the release mechanism is activated it allows the occupant to remove the restraint. There has been little or no recent development in the restraint materials as they are more than capable of withstanding the forces required. The weakest link in the restraint system is the occupant, who is unlikely to survive the forces required to break the webbing or restraint.

Developments in car restraints have been directed at friction devices such as those that use a ball bearing to provide a locking means when a belt moves too quickly i.e. in the case of a rapid deceleration. Alternatively pyrotechnic charges have more recently been employed which pretension the seat belt in response to rapid deceleration, such as a crash scenario. The detection of such an incident is usually via an accelerometer.

### SUMMARY OF THE INVENTION

According to a first aspect of the invention there is provided a restraint for restraining a load on a platform, comprising a plurality of elements successively located on at least one connection means, wherein each element possesses a convex terminus and concave terminus such that adjacent elements are in engagement through respective said concave and convex termini to allow relative rotational movement in at least one plane, wherein said at least one connection means extends through the plurality of elements to at least one terminal element at one terminus of the restraint and a tensioning means at the end distal to the terminal element, wherein tension applied to said connection means causes said elements to be under compression and retains the load upon the platform; causing the action of forcing the load against the platform.

It is desirable to provide a restraint which adopts more closely the profile of a load to be restrained, so as to provide an improved means of restraining the load against a platform, such as, for example an occupant in a seat who encounters a force during a hazardous manoeuvre or crash scenario.

The load may be cargo or an occupant. The application is suited to loads which need to be secured to the platform that is carrying the load. The platform may form part of a vessel, vehicle or craft. The term vehicle as used hereinafter will be taken to mean any form of transport, such as those used in air, land, sea or space, such as, for example aircraft both fixed- and rotary-wing, boats, cars, bicycles or lorries.

In one embodiment where the load is an occupant in a vehicle the platform may comprise a seat, such that the restraint restrains an occupant in a seat. The vehicles, in particular, may be planes or helicopters, particularly, fast moving jets, such as military fighters, other examples include cars, other road vehicles, and also motor- or water-sports type vehicles.

One advantage of the invention is that the degree of articulation i.e. the more spatial freedom and rotational freedom that each element possesses with respect to an adjacent element, the better the elements within the restraint may adopt the contours of the load or occupant. The use of articulated elements provides a more effective restraint system.

Restraints in most vehicles are typically orientated in a slight off-vertical inclination, as occupants when first seated in a vehicle are typically in a slightly reclined position. The restraint of the present invention when initially placed over an occupant will be in a relaxed state. Therefore, without any tension in the system, the weight of each element causes it to come to rest upon the surface of the occupant and so substantially adopts the contours of the occupant. Clearly, only those elements which are in close proximity with the occupant may rest on the occupant.

In the case of an occupant in a vehicle, a traditional webbed belt when placed under tension extends over the occupant in the shortest most direct path, that is to say the belt may contact the body of the occupant in only a few places, such as the shoulder, chest or abdomen areas. Therefore when the vehicle decelerates rapidly, those portions of the body which are not in contact with a webbed belt will experience further forces as the occupant is moved towards the webbed belt and away from the seat. Whereas, in the restraint according to the invention, there may be a plurality of elements which can remain in direct contact with the occupant.

After tension has been applied to the connection means, the elements become locked into a final rigid conformation, which may then optionally be locked to retain this conformation. When the rigid restraint is put under load by the occupant, an increased area of the body of the occupant will already be in direct contact with the elements, such that the body of the occupant may not move to the same degree as compared to a webbed belt. Therefore one particular advantage lies in having increased contact between the restraint and the load or occupant, such that the forces exerted on the load or occupant are more evenly distributed across the plurality of elements in the restraint.

The connection means may be any suitable means, such as, for example a connector, which may support or link the elements and other types of element such as, for example, the terminal element as hereinafter defined. When the connection means is put under tension it will cause the elements to become compressed and to adopt a substantially fixed final rigid conformation. This rigid conformation may be locked in place by the use of a locking means to retain the tension applied to said elements and terminal elements, preferably the locking means may be formed by a stop means acting on one or more retaining elements. The connection means is preferably a substantially non-extensible cord, ribbon or cable, which is threaded through the elements. The cord, ribbon or cable may be either round or rectangular in section and may be made from any suitable material such as metals, their alloys therein, synthetic fibres, natural fibres, plastics or a composite material therein. The cord, ribbon or cable may be formed from woven fibres to form a substantially circular cross section, rope like structure or may be formed from a woven strapping material which is flat or substantially rectangular in cross section. It is important that the cord, ribbon or cable is flexible and that it has a high strain value, such that repeated tensioning does not cause elongation of the cord, ribbon or cable. Particularly preferred materials are aramid fibres, such as, for example, Kevlar® or polyester fibres such as, for example, DYNEEMA®. From hereon in the term cord shall be used to describe a cord, ribbon or cable as hereinbefore defined.

The elements may be any size or shape providing that they have one terminus which is part, all, or substantially all convex and one terminus which is part, all, or substantially all concave, providing that adjacent elements may abut, and be capable of rotating in at least one plane. The elements may also be elongate, conveniently the elements dimensions will be selected to provide the best contoured shape across the load or occupant. In one embodiment in a restraint for an occupant, it may be convenient to have different length elements, such that there are smaller length elements which correspond to parts of the restraint which will be in contact with the occupant and longer elements which are less likely to come into contact with the occupant. The elements are supported and linked together by the connection means, in a preferred arrangement the connection means passes through a channel or hole passing through the central axis of said elements. This co-axial arrangement allows for the cord to be enclosed and therefore protected by the elements and increases the freedom of rotation of said elements about the cord.

There may be two or more cords which are located in one channel or hole, to provide ruggedness to the system. In an alternative arrangement there may be two or more cords located in two or more corresponding channels or holes, this may provide increased ruggedness, however this may reduce the rotational freedom of the individual elements.

As the length of each element decreases, the more effectively the restraint can adopt to the contours of the occupant. In order to allow for correct fitting, the length of the restraint may be increased or decreased according to the height of an occupant. The length may be altered by removing or adding additional elements to adjust the length of the restraint. In an alternative arrangement there may be a series of adjustable elements on the restraint which may incorporate means of adjusting their length.

In one example the adjustable element may comprise at least two members which are co-axially located, wherein at least one member may slide axially over another member to create a telescopic series of members, there may two or more members which make up the adjustable element. Alternatively, the coaxially located members may be threaded, such that rotation of one member in relation to the other member causes elongation or shortening of the adjustable element. Preferably, the members may be locked together once the correct length of restraint has been achieved, to provide a locked adjustable member. The end portions of the adjustable elements may have substantially the same convex and concave surfaces as the remaining elements in the restraint, such that they may abut the other elements in the restraint. It may be preferable that the adjustable elements are located at a point on the restraint which does not come into contact with the occupant. In a further embodiment there may be a plurality of retaining elements present on the restraint, such that the rigid conformation may be achieved by changing the exact point of fixing to take into account the different heights and sizes of occupants.

The elements and other associated elements which may be present on the restraint may be made from any suitable material such as metal or their alloys therein, plastics, rubbers, ceramics, composites or laminates. The concave and convex surfaces which abut adjacent elements must be able to move freely and should not be subject to large frictional forces when the elements are not under compression, otherwise the freedom of movement and hence the ability to adopt the contours of the load or occupant may be limited. The preferred materials for the elements' concave and convex surfaces are plastics, such as, for example, acetal homopolymer available as Delrin®, which may allow low friction interaction between the concave and convex portions of adjacent abutting elements. The element may be produced from more than one material, for example, the concave and convex surfaces may be made from a different material to the rest of the element or alternatively the concave and or convex surfaces may have a surface coating applied to allow smooth and reduced friction surfaces between adjacent elements.

In a preferred embodiment the concave and convex termini may have frustospherical surfaces to allow rotational movement between the adjacent elements in two planes. In a preferred embodiment the convex or concave termini may take the form of part, all or substantially all, of a cross-sectional slice of a sphere or hemisphere, such that each concave and convex surface has two curves. In a further preferred embodiment part or substantially all of the convex end may be spaced from the main body of the element such that there is increased lateral movement between adjacent elements in the axial plane. The sides of the elements may be curved or straight and may adopt any geometric shape. In an alternative arrangement the convex end of one element and the concave end of the adjacent element may form a cross-section of a ball and socket arrangement, where the concave portion may be re-entrant in shape, such that adjacent elements may not move apart from each other in the axial direction when there is no tension in the cord.

For a given element width, the greater the curvature of the concave and convex terminus the more rotational freedom there will be about the central axis. For smaller dimensioned loads, it may be preferable to use shorter elements with smaller radii, such that the elements may have an increased ability to substantially adopt the shape of the load or occupant to be restrained.

There may also be spacer elements which have a restricted degree of movement, which may be located between the elements and the terminal element. These spacer elements may preferably be used to replace elements where there is little or no contact with the load or occupant, such as portions of the restraint which are located towards the terminal elements and/or tensioning means. The terminal element and spacer elements may be located on two or more connection means. In one arrangement where two or more restraints converge to one terminal element or converge to a retaining element, such an element that allows convergence of two separate sets of elements into only one portion of elements, may be referred to as a substantially Y-shaped element.

The elements, as hereinbefore defined, may be covered part, all or substantially all, with a protective layer, which may be a material covering, such as a cloth, fibre or alternatively a plastic coating. The protective layer may provide comfort to the user, aesthetics and a more ergonomic feel. The protective layer may additionally prevent, in the exceptionally small occurrence, the chances of clothing or skin being pinched between adjoining elements. The protective layer may further comprise a padding layer between the user and the restraint to provide additional protection to the user. In a further arrangement there may be provided a plurality of airbag units located substantially along the length of the restraint, which are located between the occupant and the restraint. In use the airbag may be actuated in a hazard scenario as previously defined, and may provide a cushioning effect between the restraint and the user to reduce the impact of the occupant on the restraint, and reduce effects of bruising.

The elements on the connection means, when not held under compression may be free to move and substantially adopt the contour of the load. There may be sufficient elements located on the connection means such that there is only a small degree of axial movement possible between adjacent elements, therefore the elements are free to move in at least one plane, preferably two planes but have restricted axial movement.

The terminal element may comprise at least one fixing point for the at least one connection means, and optionally at least one further attachment for a release member, such that action of the tensioning means on the connection means pulls the terminal element towards said tensioning means which pulls the load against the platform, wherein the compressed elements adopt a substantially rigid conformation state. This rigid conformation may be locked in place a locking means to retain the tension applied to said elements and terminal elements, preferably by the use of one or more retaining elements which comprise a locking means. In an alternative arrangement there may be a tensioning means and a terminal element at either end of the connections means such that in use the tensioning means exerts tension on the terminal block via the connection means which is at the end distal to the tensioning means.

The fixing point may be any suitable means of securing or retaining the cord to the terminal element, such as for example, adhesive, or mechanical fastening. In one embodiment the restraint may form a car seat belt; such that both the lap restraint and shoulder restraint connection means terminate or join at the same terminal element. In an alternative arrangement a conventional five point harness may have four of the five webbed belts replaced by restraints according to the invention, preferably the two shoulder restraints and the two lap restraints. The lower abdomen part of the harness may be webbed or a restraint according to the invention. In this arrangement the respective shoulder and lap restraint may share a common connection means, which passes through a terminal element which anchors the connection means, but allows movement of the connection means in an axial direction such that the action of the tensioning means on the connection means will cause both the elements of the shoulder and lap restraints to become compressed in order to cause the restraints to be placed under tension.

The tensioning means is any suitable means, such as, for example a tensioner, for applying tension to the connection means in order to cause the elements to become compressed and adopt a substantially final rigid conformation state. The tension may be applied by pulling the connection means, such as, for example a cord, which is secured by the fixing point to the terminal element. Alternatively, displacing the connection means from its normal line by way of using a displacement cam, may afford tension in the connection means. Further tension applied to the substantially conformationally rigid restraint will cause said restraint to further restrain the load against said platform.

In one arrangement the connection means may be a cord which comprises a terminal element, which is secured at the end of the cord, a plurality of elements and optional spacer elements may be present between said elements and terminal element. The cord may be put under tension by the action of a bias, winding means or by a series of displacement cams. In one embodiment the winding means may comprise a drum, such that the cord may be in-part wound around said drum. The drum may then be rotated to wind-on the cord to provide tension to the cord via the terminal element, conversely un-winding of the cord from said drum will cause the tension in said cord to be released. The drum may be held under the action of a bias such as in a typical inertia reel system or alternatively the drum may be powered by a motor such as an Intelligent Servo System (ISS) such that the tension in the cord may be actively controlled. An Intelligent Servo System (ISS) may comprise a compact motor/gearbox assembly to replace the standard inertial reel mechanism. The ISS derives seat motion from a 3-axis accelerometer and employs Proportional, Integral, Derivative (PID) algorithms to optimally adjust the restraint characteristics.

Further tension applied to the cord by action of the motor on the drum will cause the occupant to be further restrained in the seat, it will be apparent that a finite amount of tension may be applied otherwise injury may result to the occupant through over-tensioning. In one embodiment the drum may be in-part held under the tension of a bias to keep the restraint in a part tensioned state and when required a motor may be activated to further tension the restraint.

In the arrangement where the tension means is a servo driven system, once the maximum tension, which is deemed safe for an occupant, has been applied to the restraint, the tensioning means itself may be locked into position. Alternatively, for a non-motorised system, such as an inertia reel type system, there may be pretensioning of the restraint prior to impact, by known methods.

The elements adjacent to the tensioning means may be substituted with retaining elements, which can be fixed or locked in place to allow a conformationally rigid state of the elements in the restraint to be retained. In use the connection means, such as, for example a cord, compresses the elements, spacer elements and terminal elements to a substantially final rigid conformation state, said state is then locked by locking means, which may comprise a stop means impinging on the retaining elements.

In one arrangement, the elements may be fixed by the action of the retaining elements simply impinging on the tensioning means. In a preferred arrangement the retaining elements come into contact with a stop means, which prevents movement of said element towards the tensioning means and also locks the elements into their rigid conformation. The locking means may be any locking device, barrier or clamp which prevents movement of the retaining elements. The locking means may comprise one or more stop means which preferably engages with the retaining elements, preferably the locking means is moveable, such as, for example, to allow the conformationally rigid restraint and locking means to be moved as a complete system, to allow further control of the tension applied to the now conformationally rigid restraint.

In one particular arrangement of a locking means there may be provided a retaining element, in the form of a Y shaped element, or preferably it may form a separate element comprising the lockable feature.

The stop means may, such as, for example be any stop device, and may comprise a lug or protrusion which fits into a co-locating recess or void in one or more of the retaining elements that are present. For example a mechanical or pyrotechnic driven piston actuator may be used to provide a movable protrusion to form an engagement with a void in the retaining element. One example is a Metron Actuator, which are designed to produce a high mechanical work output through rapid movement of a piston. A small current is applied which activates a pyrotechnic device, the device functions within milliseconds to achieve a rapid rate of onset.

Conveniently, a solenoid driven piston, such as a Kuhnke RM series solenoid actuator may be used. This provides the further advantage that the piston may be repeatedly engaged and disengaged and is therefore a reversible means of locking the retaining element in place. In an alternative arrangement the lug or protrusion may be formed on the retaining element and a co-locating recess or void may form the remaining part of the stop means.

In one arrangement the lug or protrusion may be moved by a mechanical means, such as an actuator, motor or bias, such as, for example, by use of a sprung piston, which is forced onto the sides of the retaining element.

When the connection means is placed under tension the locking element is drawn towards the actuator, such that at the point where actuator piston and recess of said retaining element are co-located, the bias or servo will force a protrusion, such as a piston, into a locking engagement with the recess. At this point the elements are locked in a compressed state. In one arrangement the locked and compressed state may correspond to the restraints maximum restraining force. In this arrangement no further tensioning of the restraint system is required. In an alternative arrangement the locking means may be activated to cause the rigid conformation of the restraint to be produced, prior to the maximum restraining force of the restraint being reached.

Conveniently the lug or protrusion may be removed from the locking engagement by action of the actuator or by a separate servo means designed to overcome the bias. In a preferred arrangement the lug or protrusion may be exclusively activated by a servomotor or solenoid actuator.

The operation of this locking mechanism offers a reaction against the pull of the tensioning cables resulting in a fully tensioned restraint.

Therefore, in the case of an occupant restraint, during normal use, the occupant may wish to move around to use non-essential features of the vehicle. The connection means may be free to move in relation to the tensioning means. In an active restraint system, the connection means, such as a cord, is put under tension by action of a servo which pulls the restraint firmly against the occupant, continued tensioning causes the elements to be compressed together. In order to adopt a conformationally rigid state, the elements must be compressed against a stop, such as, for example the actuator and retaining elements, as hereinbefore defined. Clearly further compression of the elements in the restraint when it has reached the conformationally rigid state will not cause any further advantage. Once the restraint has formed a conformationally rigid state the restraint and locking means may together be put under further tension, by pulling the cord, which draws both the restraint and locking means towards the occupant. In this arrangement the locking means is moveable such as to allow the conformationally rigid restraint to be further pulled against the occupant and hence to further restrain the occupant in the seat.

In an alternative arrangement the locking means may be activated manually by the occupant, once a desired rigid conformation has been achieved.

In one example a five point harness arrangement typically comprises two shoulder straps which come down over the nipple lines of an occupant and meet at the abdomen at a release plate. In one particular embodiment the straps may be a restraint according to the invention, such that each shoulder restraint may have its own tensioning means or more preferably the tensioning means may be common to both connection means.

In a particularly preferred embodiment a conventional five point harness may have the two shoulder restraints and the two lap restraints as restraints according to the invention. The respective shoulder and lap restraint may share a common connection means, which passes through a terminal element which anchors the connection means, but allows movement of the connection means in an axial direction such that the action of the tensioning means on the connection means will cause the elements of both the shoulder and lap restraints to become compressed in order to cause the restraints to be placed under tension. Preferably the cords from both sets of shoulder and lap restraints will be attached to one tensioning means.

In a further embodiment there is provided a method for actively controlling the tension of the cord, wherein the degree of restraint of the load against the platform is selected in response to force placed upon the load. This may be detected by a detection means, such as, for example, a detector capable of determining external forces acting upon said load. These forces may be readily gauged by use of one or more accelerometers.

Accordingly there is provided a restraint system comprising an engaging point located on said platform which selectively engages with a release member, said release member being attached to at least one restraint according to the invention.

Accordingly there is provided an active restraint system, comprising at least one restraint according to the invention and a detection means which actively controls at least one tensioning means as hereinbefore defined. The detection means may be any device which can detect forces, such as acceleration, deceleration. It may be necessary to have a plurality of detection devices so that the force and its vector may be resolved. The detection devices may either directly be linked to the tensioning means to actively control the tension to the connection means or preferably the detection means may provide a signal to a processor which actively controls one or more tensioning means. Preferably it will actively control all of the tensioning means to keep the load against the platform. The detection means may also comprise sensors which monitor any potential source of hazard or manoeuvre event which may cause the load to experience a force which would otherwise result in excess movement of the load, such as for example, turbulence, sudden manoeuvres (i.e. action by the occupant on the steering and power systems, weather conditions, engine performance etc).

It may be envisaged that an active restraint system may be applied to conventional webbed belts, such that accordingly there is provided a method of restraining an occupant in a vehicle, vessel or craft by actively controlling the tension of at least one webbed belt in response to a detection means, such as, for example a detector capable of detecting movement, for example an accelerometer. There may be further provided an active restraint system, comprising one or more webbed belts, a tensioning means for applying tension to say webbed belts and a detection means which actively controls said tensioning means to cause said webbed belt to pull the load against the platform.

The mass of the load and more significantly the dimensions of an occupant are critical to the performance and the effectiveness of any restraint. For example in a fast jet it is vital that each part of the 5 point harness is correctly fitted to each occupant. In a preferred embodiment there is a recognition system which upon referencing with an identification source will provide the correct length of restraint and tension settings to the restraint or active restraint system, such that any occupant may easily use any available plane. The identification source may be any means of imparting the anthropometric data to the platform, such as the plane. In one embodiment the identification source may have the biometric data stored on a chip or memory device, such as for example Ibutton™ which then may be transferred to the recognition system. The Ibutton™ is a contact memory button which stores the pilot details and imparts them to the recognition system in the plane. In an alternative arrangement the biometric data may be stored in the recognition system on the plane and the identification source may activate a particular setting. The anthropometric data will at minimum contain the mass and dimensions of the occupant, which are sufficient to provide the correct settings for the restraint or active restraint system i.e. to select the amount of tension for normal operation and also in case of hazardous manoeuvres as hereinbefore defined. Optionally the occupant's personal identification may be included as part of the data. In a mass production vehicle this data may be manually inputted by the user or more predetermined values may be used.

The load may be freight or an occupant of a vehicle as hereinbefore defined, therefore according to a further aspect there is provided a freight restraint comprising one or more restraints according to the invention. Freight or cargo on a moving truck, plane or boat may also present a hazard to the occupants who are piloting the vehicle. Clearly, the freight must be secured to the platform in order to keep the centre of gravity consistent, stabilise the freight and prevent the freight from falling off of or out of the vehicle. In a further embodiment there is an active restraint system as hereinbefore defined for restraining freight on a platform. In most cases freight is usually square-sided and is simply strapped down to the vehicle. However, for abnormal loads or where freight is not uniformly shaped, i.e. has contoured or curved portions the traditional straps will take the shortest path and so the straps may only provide one or two points of contact with the load. The advantage of the restraints or active restraint system according to the invention is that the elements and hence restraint may substantially adopt the shape of the freight, therefore providing better contact between the restraint and the freight. Typically freight such as building materials, logs, sections of pipes may be more firmly secured by such a means. In the case of an occupant restraint the elements adopt the contours of the body of the occupant due to gravity. However in a load restraint, certain elements may be in an orientation which does not naturally rest on the surface of the load, and so may need to be temporarily held in place on the surface of the load whilst tension is applied to the cord. A yet further advantage is that the restraint of the load may be actively controlled during manoeuvres, such that, for example, during take off or landing in a plane, manoeuvring around a corner or roundabout in a truck, or encountering roll or pitch in a ship. In these situations the tension of the restraint may be increased or decreased accordingly and where there are two or more restraints the tension in different directions across said load may be selectively and actively tensioned to increase the stability of the load on the platform.

There is further provided a five point harness comprising at least one restraint according to the invention or an active restraint system according to the invention. In a preferred arrangement the at least one shoulder restraint and the at least one lap restraint are located on a common connection means.

There is further provided a seat belt for a vehicle comprising at least one restraint according to the invention or an active restraint system according to the invention. Preferably both parts of the two point seat belt are restraints according to the invention.

It is clearly desirable to provide advancements in restraint technology and crash sensing techniques as these offer an improvement in the survivability of aircrew as well as a reduction in injuries sustained during an impact or heavy landing. The restraints that are currently in use commonly experience problems such as webbing stretch, harness positioning and restraint sizing which lead to further stress and strain on the pilot. It is therefore desirable that the active restraint system and the restraint are fully adjustable in order that all sizes of occupant are offered the same amount of protection during normal flight or crash conditions.

For example if a pilot of a fast jet prepares to undertake a particular manoeuvre, the active restraint system may take readings from the movement of the joystick, control surfaces and the engine power to provide the correct level of tension in the one or more restraints in the five point harness to keep the pilot in the correct seating position. This data may also be achieved from data from the steering wheel of a road vehicle. This data may form part of a predictive detection means. Additionally detectors which are reactive may detect the forces actually being incurred by the pilot and so may provide further data to increase or decrease tension in reaction to the sensor readings in any one of the restraints. Further there may be provided proactive sensor arrangements, which detect the environment such as, for example, weather, altitude, terrain, turbulence etc, such that when there is an increased likelihood of risk or hazard, such as poor weather, the restraint or active restraint system may take the precaution of adjusting the tension in the expectation of a hazard.

In particular fast moving jets or helicopters may often encounter sudden drops in altitude due to air currents or extreme manoeuvres where the occupant may slide up in their seat. The external forces may be that of positive or negative G forces acting in any direction upon said load. The invention has particular benefit in that the at least one restraint may be activated to counteract said movement by applying tension to said connection means via the tensioning means to firmly restrain the occupant in their seat.

Improvements in occupant restraint may be attained by offering a correctly fitted and adjusted restraint by alternative positioning of the restraint system anchor points. The recognition system and identification source provides this data and selects the optimum shoulder height and lap strap anchor point position for that occupant. Mechanical adjustments may be implemented via stepper motor and gearbox assemblies, with feedback from linear position encoders. Whereas current restraint systems are fixed systems which apart from the ability to adjust the harness webbing for comfort and tightness, offer no ability to adjust its response to an impact when worn by occupants of different mass, sitting height or buttock width.

Additionally, further sensors may weigh the occupant when located in the seat, in preference to a previously recorded mass, then adjust the severity of the response of the restraint thus minimising the induced deceleration levels and snatch loads on the occupant's body. It will be apparent that the restraint is suitable for both operators and or passengers of the vehicle vessel or craft.

Embodiments of the invention are described below by way of example only and in reference to the accompanying drawings in which:

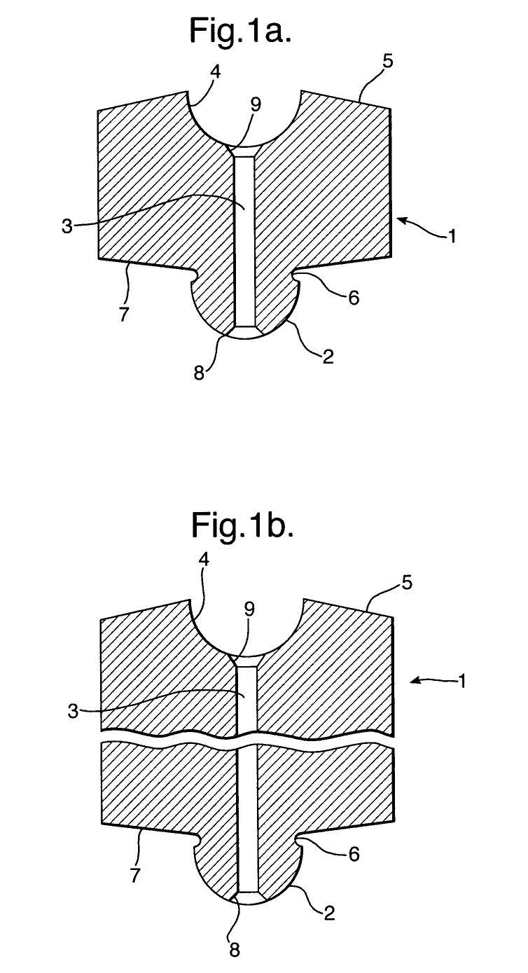

FIG. 1a shows a top view of a cross section slice of an element.

FIG. 1b shows a top view of a cross section slice of an elongate element

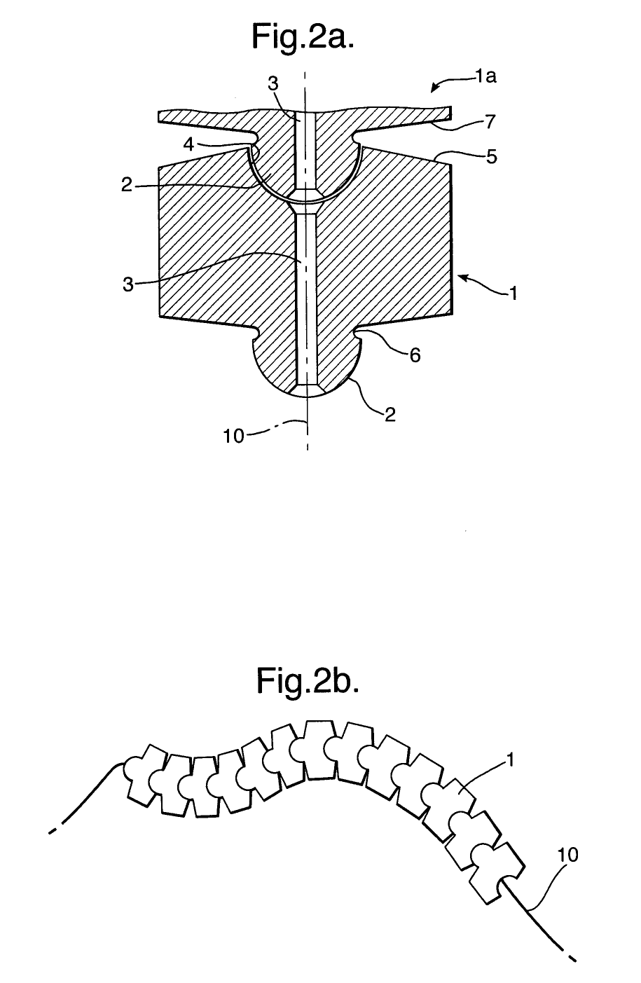

FIG. 2a shows a top view of a cross section slice of the engagement of two elements.

FIG. 2b shows a plurality of elements on a cord.

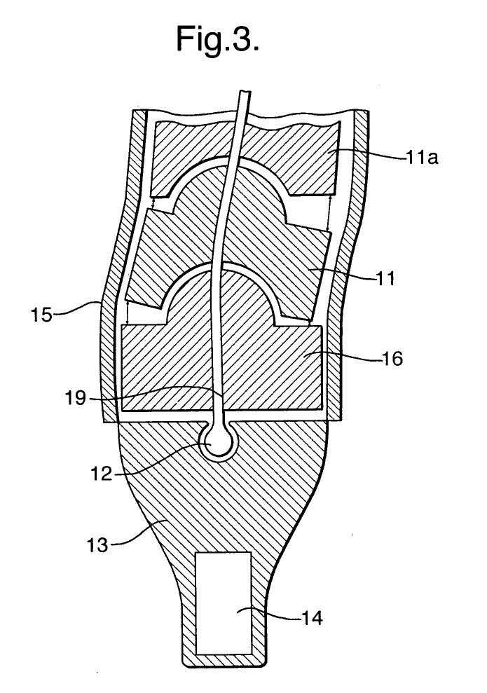

FIG. 3 shows a terminal element with a release member suitable for a five point harness or car seat belt.

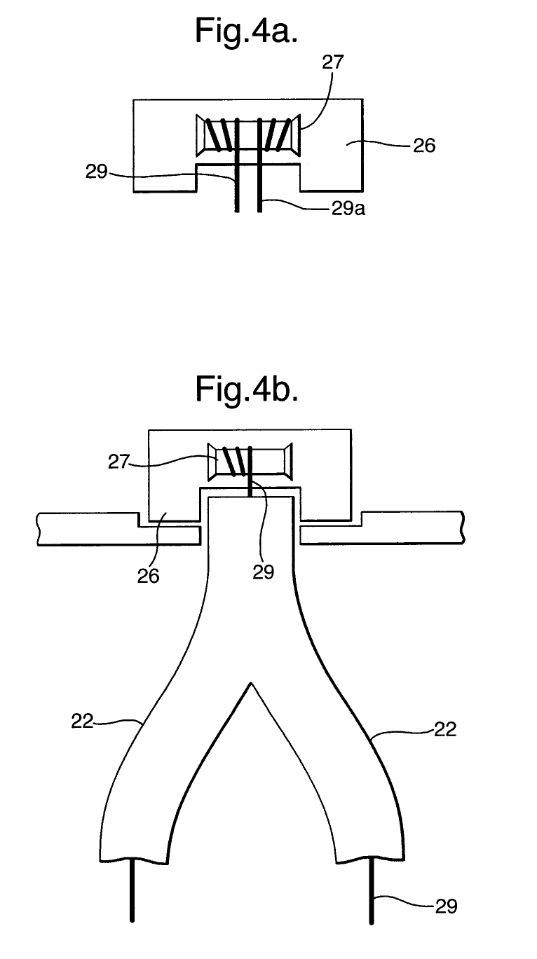

FIGS. 4a and b show a winding drum for applying tension to a connection means.

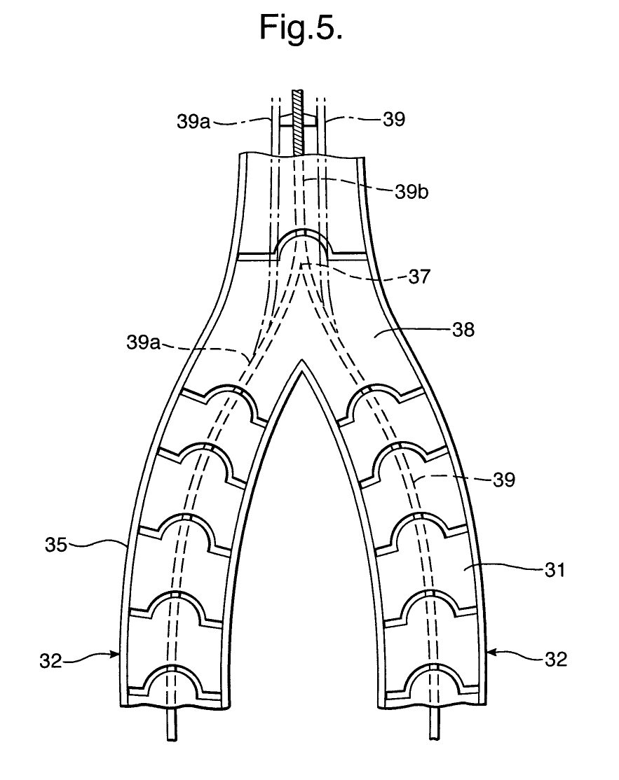

FIG. 5 shows a Y-shaped element and two shoulder restraints.

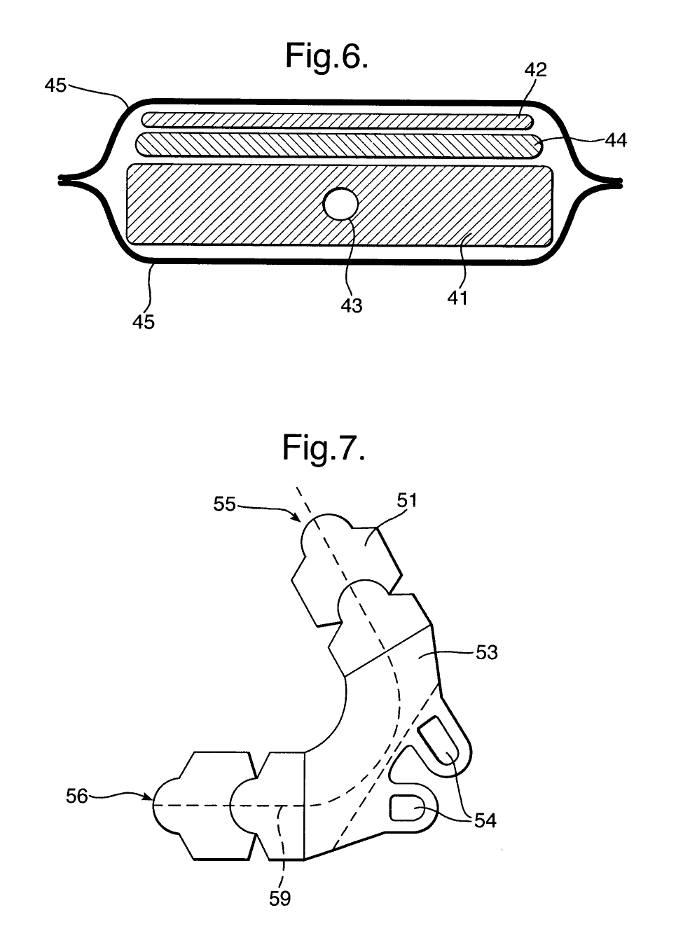

FIG. 6 shows an element with an air bag and padding layer.

FIG. 7 shows a release member for a combined shoulder and lap restraint for a five point harness.

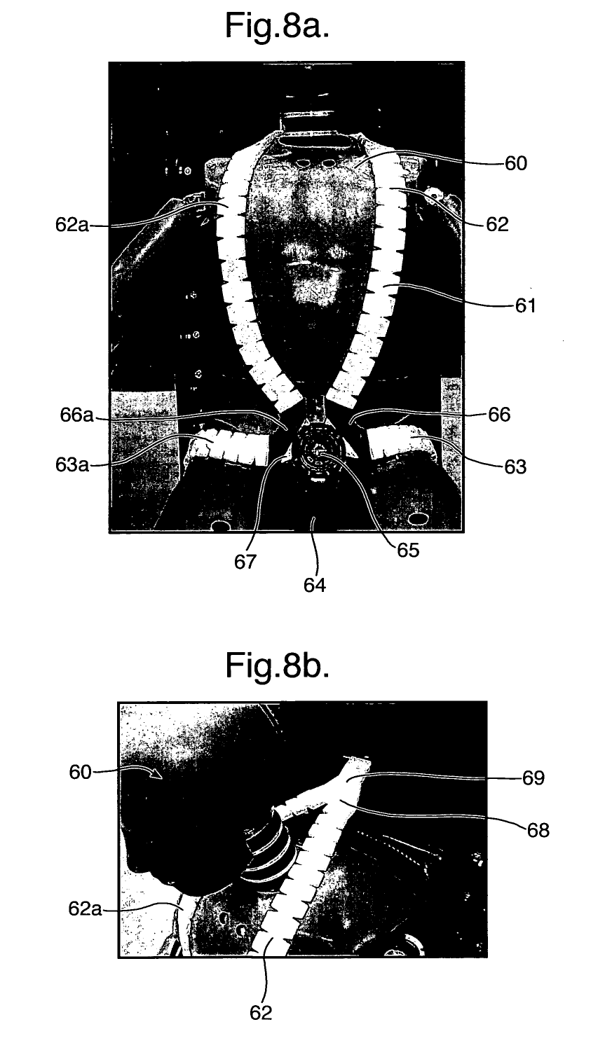

FIGS. 8a and 8b show a restraint in position on an Anthropomorphic Test Device ATD.

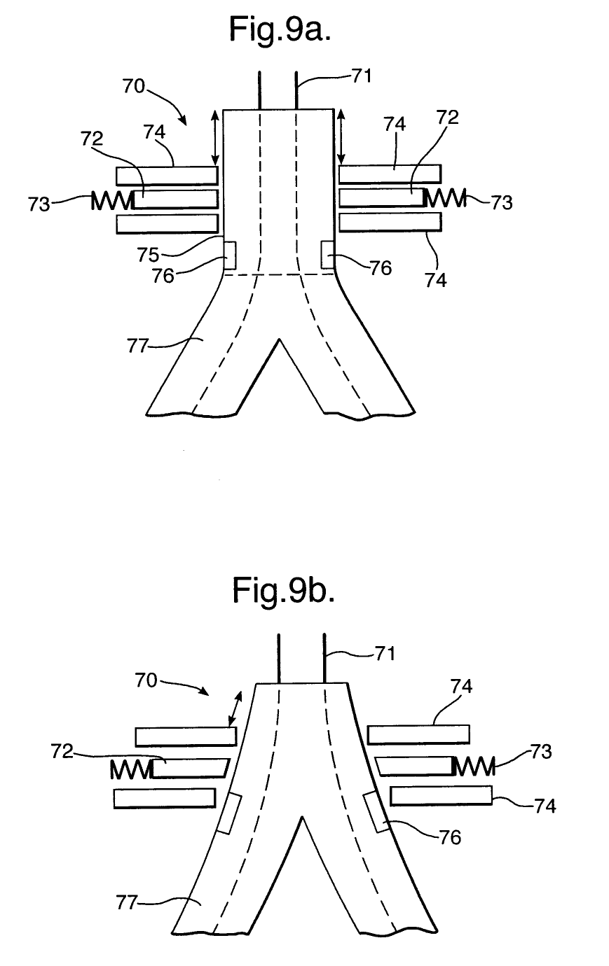

FIGS. 9a and 9b show a locking means for locking the restraint in a rigid conformation.

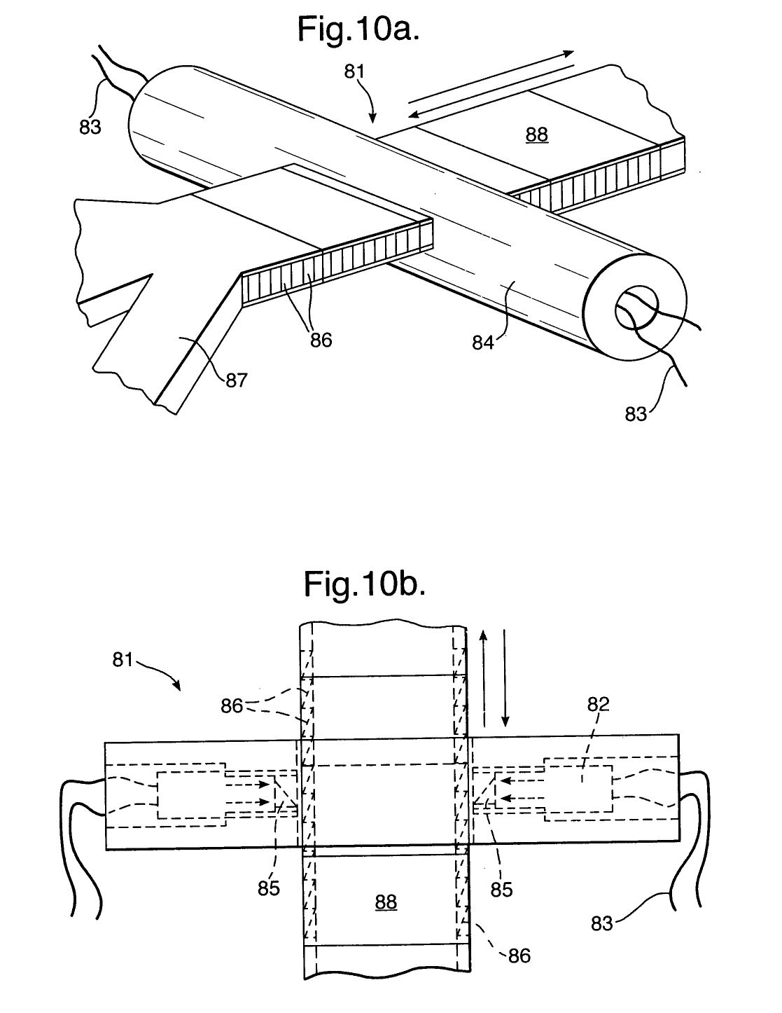

FIG. 10a shows a side view of a locking arrangement of a series of retaining elements and retaining means which fixes the tension imparted to elements and terminal elements. FIG. 10b shows a cross section of the locking arrangement in FIG. 10a.

Turning to FIG. 1a, this shows a top view of a cross section slice of an element 1 which has a convex end 2 and a concave end 4. There is provided a hole 3 which runs the entire length of the element 1 which can accommodate a cord or cable (not shown). The hole 3 may be circular or square in cross section. The element 1 preferably has a convex end 2 which is spaced from the main body such that there is a small shoulder 6 to provide increased rotation in both planes, when co-operatively engaged with an adjacent element (not shown). To provide yet further movement between adjacent elements the end portions of the element adjacent to the convex surface 2 may have sloped shoulders 7. Similarly the other end bearing a concave surface may also possess sloped shoulders 5.

There may be countersunk portions 8 and 9 at the convex and concave ends respectively of the hole 3, to allow the cord or cable to conform to the different positions that adjacent elements may adopt.

FIG. 1b shows an element 1 with a more elongated body than the element of FIG. 1a.

FIG. 2a shows the convex surface 2 of one element 1a (shown in part) in engagement with the concave end 4 of an adjacent element 1. The sloped shoulders 7 and elongated convex end 6 of element 1a and the sloped shoulders 5 of element 1 provide the degree of movement between adjacent elements. The cord or cable 10 will pass through holes 3 to co-axially locate adjacent elements. When the cord is tensioned and the elements are pushed together the convex surface 2 and concave surface 4 become locked rigid in whatever conformation they have adopted. FIG. 2b shows a plurality of elements 1 on a cord 10.

FIG. 3 shows a terminal element 16, with an integral release member 13. There is a fixing point 12 for the cord or cable 19. The fixing point 12 is located in the integral terminal element. In this particular arrangement the slightly enlarged radius end of the fixing point partially impinges and therefore acts upon the re-entrant shoulder of the release member 13. Clearly, the fixing point may be located such that it only impinges on the terminal element.

The terminal element 16 may be integral with the release member as shown or it may form a separate co-joined section. The release member 13 may comprise a hole 14 which locates in a conventional fastening typically found on a seat belt or a five point harness. Alternatively the release member may provide a male type connector for a seat belt or a five point harness fastening. As the cord 19 is pulled towards the elements 11, 11a, 11 n^{th}(last element not shown), the convex surface of integral terminal element 16 will be caused to move against the concave surface of element 11 and so on until all the elements become locked together and form a substantially conformationally rigid restraint.

FIG. 4a shows a tensioning means which is a drum 27 in a housing 26 which is driven by a servomotor with a gearing system (not shown) which winds two cords 29 and 29a from two separate restraints onto the drum 27. As the drum 27 is rotated to increase the number of windings of cords 29 and 29a on the drum 27, further tension will be applied to both cords, as they pull against the terminal element (not shown). Un-winding cords 29 and 29a will decrease the tension in both cords, accordingly.

FIG. 4b shows an alternative arrangement for a five point harness where the two shoulder straps 22 join at a Y-piece (see FIG. 5 for example) which is then tensioned by only one cord 29 which may be wound on a drum 27 in a similar fashion to that described with reference to FIG. 4a.

FIG. 5 shows two arrangements for two shoulder restraints 32 from a five point harness (not shown in completion). Each shoulder restraint has a plurality of elements 31, covered with a protective layer 35, which meet at a Y-shaped element 38. The Y-shaped element 38 is located behind the neck of the occupant (not shown) such that elements 31 on both restraints would come across the occupant's shoulders and down to a quick release member (see FIG. 8a). In one arrangement the two cords 39 and 39a from respective restraints may meet at a joining point 37 inside said Y-element 38, a further cord 39b may be joined at the joining point 37 which may then be tensioned by a winding drum as shown in FIG. 4b. Therefore tension provided to cord 39b will cause the two separate cords 39 and 39a to become tensioned.

In an alternative arrangement cords 39 and 39a may pass through the Y-element through two holes (dotted lines) and both cords 39 and 39a may be wound on a drum as shown on FIG. 4a. In yet a further arrangement each cord 39 and 39a may be wound onto separate drums such that each restraint may be independently tensioned.

FIG. 6 shows an element 41 in cross section as an end view, with a hole 43 which can accommodate the connection means (not shown), such as a cord or cable. On one side of the element 41 there may be located an optional conventionally operated car type airbag 44 and a padding layer 42, to provide a degree of comfort to the occupant. The element 41, airbag 44 and padding 42 may then be further housed in a protective layer 45. The protective layer 45 may be a cloth material or even a webbed belt. It may be desirable to fit the active restraint system, airbag, padding retro-fit to an existing five point harness system or seat belt. The airbag 44 may be any conventional airbag system, adapted to the required size to fit on one or more of the elements 41. There may be one airbag or a plurality of smaller airbags located along part or all of the restraint. Activation of the airbag 44 may be carried out by known means and may preferably be activated at a given threshold force level.

FIG. 7 shows a release member 53 which has two holes 54 which may connect directly to a standard five point harness quick release buckle (not shown). In one arrangement the two restraints 55 and 56 form respectively a shoulder restraint and a lap restraint which converge at the release member 53. There is a cord 59 which is common to both restraints 55 and 56. Release member 53 houses the cord 59 and allows it to move freely, such that both restraints 55 and 56 may use release member 53 as a common terminal element. Therefore as the cord 59 is tensioned both the shoulder restraint 55 and a lap restraint 56 are tensioned at the same time. Clearly if the release member had the arrangement as shown in FIG. 3 (i.e. one hole) then this could be used for a lap and diagonal strap in a car or lorry.

FIG. 8a shows an ATD 60, with shoulder restraints 62 and 62a comprising a plurality of elements 61, which are placed over each shoulder. The shoulder restraint 62 meets a release member 66 of the type shown in FIG. 7. The lap restraint 63 also meets the release member 66. A cord (not shown) which is common to both shoulder restraint 62 and lap restraint 63 passes through the release member 66. The release member 66 may also be a terminal element i.e. the cord is placed under tension and acts against the release member 66. Conveniently, the terminal element may be located at the end of lap restraint 63. Upon applying tension to the cord both shoulder restraint 62 and lap restraint 63 via release member 66, will tension all of the individual elements and cause the restraints 62 and 63 to become substantially conformationally rigid and force the occupant in to the seat. There may be a tension means at the end of shoulder restraint 62 and lap restraint 63 or just one tension means which tensions both restraints. The lugs 67 which form part of the release member 66 may then slot into a standard quick release locking unit 65 for a five point harness. The lower abdomen portion 64 may be a traditional belt or a restraint according to the invention. A particular advantage is that both shoulder restraint 62 and lap restraint 63 can be tensioned at the same time therefore more securely restraining the occupant in the seat. Similarly shoulder restraint 62a and lap restraint 63a pass through the release member 66a which may connect to the release locking unit 65. The tension in (62a and 63a) and (62 and 63) may be independently applied by separate tensioning means or by a common tensioning means.

In FIG. 8b there is shown the neck and shoulder section of an ATD 60, in this particular configuration the shoulder restraints 62 and 62a (obscured) meet at a Y-element 68 as shown in FIG. 5. There may be further spacer elements or retaining elements 69 between the Y-element 68 and the tensioning means (not shown).

FIG. 9a shows one example of a set up for locking means 70, for locking a terminally located retaining element 75 in position against a stop means feature, formed of a pair of lugs or protrusions 72, which fit into a co-locating recesses or voids 76 in the retaining element 75. In one arrangement the lugs or protrusions 72 may be actively biased by springs 73 onto the sides of the element 75. A guide or housing 74, which is abutted against the lug or protrusion 72, ensures that the lug or protrusion stays in contact with the elements. When the connection means or cord 71 is placed under tension the element 75 will be drawn towards the lugs 72. At the point where protrusion 72 and recess 76 are co-located, the bias will force the protrusion 72 into a locking engagement with the recess 76. FIG. 9b shows a similar set up except that the recesses 76 are located on a Y-shaped element 77.

FIG. 10a and 10b show a preferred example of an arrangement for providing a locking means 81. The locking means 81 is provided by a number of retaining elements 88, which comprises a series of recesses 86 in at least one, preferably two surfaces and a stop means housing or guide 84, which has located inside a stop means in the form of a piston actuator 82, which may either be mechanically or pyrotechnically driven. The actuator contains a pin 85 which when activated is driven into the recesses 86.

It could be envisaged that an actuator possessed a means of reversibly engaging with a protrusion located on the retaining element 88.

In operation compression will be imparted to all of the elements, the compression is caused by the tension applied to the cord, said tension acting on the terminal element. Once the desired amount of tension is imparted, the elements will adopt and retain the conformation of the surface of the load or occupant. The locking means will activate by interaction of the stop 84 acting on the retaining elements 88 as outlined above. The restraint will then be held firm against the load in a conformationally locked state. Further tension applied to the cord will cause further tension to be applied between the restraint and the load or occupant.

1.-34. (canceled)

35. A restraint for restraining a load on a platform, comprising a plurality of elements successively located on at least one connection means, wherein each element possesses a convex terminus and concave terminus such that adjacent elements are in engagement through respective said concave and convex termini to allow relative rotational movement in at least one plane, wherein said at least one connection means extends through the plurality of elements to at least one terminal element at one terminus of the restraint and a tensioning means at the end distal to the terminal element, wherein tension applied to said connection means causes said elements to be under compression and retains the load upon the platform.

36. A restraint according to claim 35 wherein the load is cargo or an occupant in a vehicle, vessel or craft.

37. A restraint according to claim 35 wherein the restraint substantially adopts the contour of the load or occupant.

38. A restraint according to claim 36 wherein the restraint restrains an occupant in a seat.

39. A restraint according to claim 35 wherein the connection means is a non extensible cord or cable.

40. A restraint according to claim 39 wherein the cord or cable is an aramid or polyester woven fibre.

41. A restraint according to claim 35 wherein the terminal element comprises at least one fixing point for the at least one connection means, and optionally at least one further attachment for a release member or an integral release member.

42. A restraint according to claim 35 wherein there is a tensioning means and a terminal element at either end of the connection means such that in use the tensioning means exerts tension on the terminal element which is at the end distal to the tensioning means.

43. A restraint according to claim 35 which comprises a locking means to retain the tension applied to said elements and terminal elements.

44. A restraint according to claim 43 wherein the locking means is provided by a stop means capable of interaction with one or more retaining elements.

45. A restraint according to claim 35 wherein the tension means is a resilient means, winding drum or one or more displacement cams.

46. A restraint according to claim 45, wherein the winding drum is powered by a servomotor or bias.

47. A restraint according to claim 35 wherein the elements are elongate in the direction parallel to the connection means.

48. A restraint according to claim 35 wherein the concave and convex surfaces are frustospherical to allow rotational movement between adjacent elements in more than one plane.

49. A restraint according to claim 48 wherein the concave and convex surfaces take the form of cross-sectional slices of hemisphere.

50. A restraint according to claim 49 wherein the convex surface is spaced from the main body of the element.

51. A restraint according to claim 50 wherein the concave end is re-entrant.

52. A restraint according to claim 35 wherein the elements are made from metals or alloys thereof, plastics, rubbers, ceramic, composites or laminates.

53. A restraint according to claim 35 wherein the elements are covered part, all or substantially all with a protective layer and optionally a padding layer.

54. A restraint according to claim 53 wherein there is provided a plurality of airbag units located substantially along the length of the restraint, located between said restraint and protective layer.

55. A restraint system comprising an engaging point located on a platform which selectively engages with a release member, said release member being attached to at least one restraint according to claim 35.

56. A method of restraining a load against a platform by actively controlling the tension of at least one connection means in response to a detection means.

57. A method according to claim 56 wherein the detection means is at least one accelerometer.

58. An active restraint system, comprising at least one restraint according to claim 35.

59. An active restraint system according to claim 58 wherein the system comprises a recognition system and identification source.

60. An active restraint system according to claim 59 wherein the recognition system and identification source provide anthropometric data of an occupant or mass of a load.

61. A five point harness comprising at least one restraint according to claim 35.

62. A five point harness according to claim 61 wherein at least one shoulder restraint and at least one lap restraint are located on a common connection means.

63. A seat belt for a vehicle comprising at least one restraint according to claim 35.

64. A seat belt for a vehicle according to claim 63 wherein at least one shoulder restraint and at least one lap restraint are located on a common connection means.

65. A method of restraining an occupant in a vehicle vessel or craft by actively controlling the tension of at least one belt in response to a detection means.

66. An active restraint system, comprising at least one belt which in use is used in a method according to claim 65.

67. An active restraint system according to claim 66 wherein the restraint is a webbed belt.

68. A restraint according to claim 35 wherein the connection means is co-axial to said elements, such that it passes through the central axis of said elements.
